(19) United States
(12) Patent Application Publication
(10) Pub. No.: US 2005/0129589 A1
(43) Pub. Date: Jun. 16, 2005

(54) Multi-layered photocatalyst/thermocatalyst for improving indoor air quality

(76) Inventors: Di Wei, Manchester, CT (US); Thomas H. Vanderspurt, Glastonbury, CT (US); Rakesh Radhakrishnan, Vernon, CT (US); Stephen O. Hay, South Windsor, CT (US); Timothy N. Obee, South Windsor, CT (US); Wayde R. Schmidt, Pomfret Center, CT (US)

Correspondence Address: CARLSON, GASKEY & OLDS, P.C., 400 WEST MAPLE ROAD, SUITE 350, BIRMINGHAM, MI, 48009, US

(21) Appl. No.: 10/736,921

(22) Filed: Dec. 16, 2003

(51) Int. Cl. B05D 1/40; B32B 9/00; B01D 53/34

(52) U.S. Cl. 422/177; 427/331; 428/701; 428/702; 428/697; 428/336

(57) ABSTRACT

A layered photocatalytic/thermocatalytic coating oxidizes contaminants that adsorb onto the coating into water, carbon dioxide, and other substances. The layered coating includes a photocatalytic outer layer of titanium dioxide that oxides volatile organic compounds. The coating further includes an intermediate layer of Group VIII noble metal doped titanium dioxide that oxidizes low polarity organic molecules. An inner layer of gold on titanium dioxide oxidizes carbon monoxide to carbon dioxide. When photons of the ultraviolet light are absorbed by the coating, reactive hydroxyl radicals are formed. When a contaminant is adsorbed onto the coating, the hydroxyl radical oxidizes the contaminant to produce water, carbon dioxide, and other substances.

### BACKGROUND OF THE INVENTION

The present invention relates generally to a multi-layer photocatalyst/thermocatalyst coating that decomposes ozone and oxidizes gaseous contaminants, including volatile organic compounds, low polarity organic molecules, and carbon monoxide, that adsorb onto the photocatalytic surface to form carbon dioxide, water, and other substances.

Indoor air can include trace amounts of contaminants, including carbon monoxide, ozone, and volatile organic compounds (VOCs) such as formaldehyde, acetaldehyde, toluene, propanal and butene, etc. Absorbent air filters, such as activated carbon, have been employed to remove the volatile organic compounds from the air. As air flows through the filter, the filter blocks the passage of the contaminants, allowing contaminant free air to flow from the filter. A drawback to employing filters is that they simply block the passage of contaminants and do not destroy them. In additional, air filters are not effective in blocking carbon monoxide and ozone.

Titanium dioxide has been employed as a photocatalyst in an air purifier to destroy contaminants, especially polar organic molecules. When the titanium dioxide is illuminated with ultraviolet light, photons are absorbed by the titanium dioxide, promoting an electron from the valence band to the conduction band, thus producing a hole in the valence band and adding an electron in the conduction band. The promoted electron reacts with oxygen, and the hole remaining in the valence band reacts with water, forming reactive hydroxyl radicals. When a contaminant adsorbs onto the titanium dioxide catalyst, the hydroxyl radicals attack and oxidize the contaminants to water, carbon dioxide, and other substances.

Doped or metal oxide treated titanium dioxide increases the effectiveness of the titanium dioxide photocatalyst. However, titanium dioxide and doped titanium dioxide are less effective or not effective in oxidizing carbon monoxide and low polarity organic molecules and decomposing ozone. Carbon monoxide (CO) is a colorless, odorless, and poisonous gas that is produced by the incomplete combustion of hydrocarbon fuels. Carbon monoxide is responsible for more deaths than any other poison and can build up in indoor air due to improper ventilation, cigarette smoke, or automobile emissions in outdoor air. Carbon monoxide poisoning can occur in the presence of small quantities of carbon monoxide over long periods of time. Sensitive organs such as the brain, heart, and lungs suffer most from a lack of oxygen. The EPA mandated exposure over an eight hour average is set at 30 ppm.

Ozone (O₃) is a pollutant that is released from equipment commonly found in the workplace, such as copiers, printer, scanners, etc. Ozone can cause nausea and headaches, and prolonged exposure to ozone can damage nasal mucous membranes, causing breathing problems.

Hence, there is a need for a multi-layer photocatalyst/thermocatalyst coating that decomposes ozone to oxygen and oxidizes carbon monoxide, low polarity organic compounds, and volatile organic contaminants that adsorb onto the photocatalytic surface to form carbon dioxide, water, and other substances.

### SUMMARY OF THE INVENTION

A layered photocatalyst/thermocatalyst coating on a substrate purifies air in a building or a vehicle by decomposing and oxidizing any contaminants that adsorb onto the coating to oxygen, water, carbon dioxide, and other substances.

A fan draws air into an air purification system. The air flows through an open passage or channel of a honeycomb. The surface of the honeycomb is coated with a layered photocatalytic/thermocatalytic coating. An ultraviolet light source positioned between successive honeycombs activates the coating.

The coating includes a photocatalytic outer layer of titanium dioxide or metal oxide loaded titanium dioxide that oxidizes volatile organic compounds to carbon dioxide, water, and other substances. A photocatalytic intermediate layer of a noble metal/titanium dioxide coating is located under the outer layer. Beneath the intermediate layer is a photocatalytic/thermocatalytic inner layer of nano-dispersed gold on titanium dioxide that is applied on the honeycomb.

When photons of the ultraviolet light are absorbed by the outer layer of titanium dioxide, reactive hydroxyl radicals are formed. When a contaminant, such as a volatile organic compound, is adsorbed onto the coating, the hydroxyl radical attacks the volatile organic compound, abstracting a hydrogen atom from the volatile organic compound and oxidizing the volatile organic compound to water, carbon dioxide, and other substances. The outer layer has a thickness less than 2 μm to allow the photons to penetrate the outer layer to reach the underlying photocatalytic layer of platinum/titanium dioxide.

Platinum deposited on the surface of titanium dioxide enhances the separation of charge carriers, decreasing the recombination rate of the electrons and holes. Platinum is also a good thermal catalyst. It is believed that platinum can further oxidize the photocatalytic oxidation intermediates to carbon dioxide and water.

Carbon monoxide can diffuse through the porous layers and reach the inner layers. At room temperature, the gold/titanium dioxide layer oxidizes carbon monoxide to carbon dioxide. When carbon monoxide adsorbs on the coating, the gold acts as an oxidation catalyst and lowers the energy barrier of the carbon monoxide, oxidizing the carbon monoxide to carbon dioxide in the presence of oxygen.

In environments where ozone concentrations are very high, a fourth layer of manganese oxide/titanium dioxide is applied on the honeycomb under the inner layer. Ozone can also diffuse through the porous layers and reach the inner layers. When ozone adsorbs on the manganese oxide/titanium dioxide coating, the manganese oxide decomposes the ozone to molecular oxygen at room temperature or slightly elevated temperature due to the heat generated by the ultraviolet light.

These and other features of the present invention will be best understood from the following specification and drawings.

### BRIEF DESCRIPTION OF THE DRAWINGS

The various features and advantages of the invention will become apparent to those skilled in the art from the following detailed description of the currently preferred embodiment. The drawings that accompany the detailed description can be briefly described as follows:

FIG. 1 schematically illustrates an enclosed environment, such as a building, vehicle or other structure, including an interior space and an HVAC system;

FIG. 2 schematically illustrates the air purification system of the present invention;

FIG. 3 schematically illustrates the honeycomb of the air purification system;

FIG. 4 schematically illustrates a first example of the layered photocatalyst of the present invention;

FIG. 5 schematically illustrates a second example of the layered photocatalyst of the present invention; and

FIG. 6 schematically illustrates an alternate embodiment of the air purification system.

### DETAILED DESCRIPTION OF THE PREFERRED EMBODIMENT

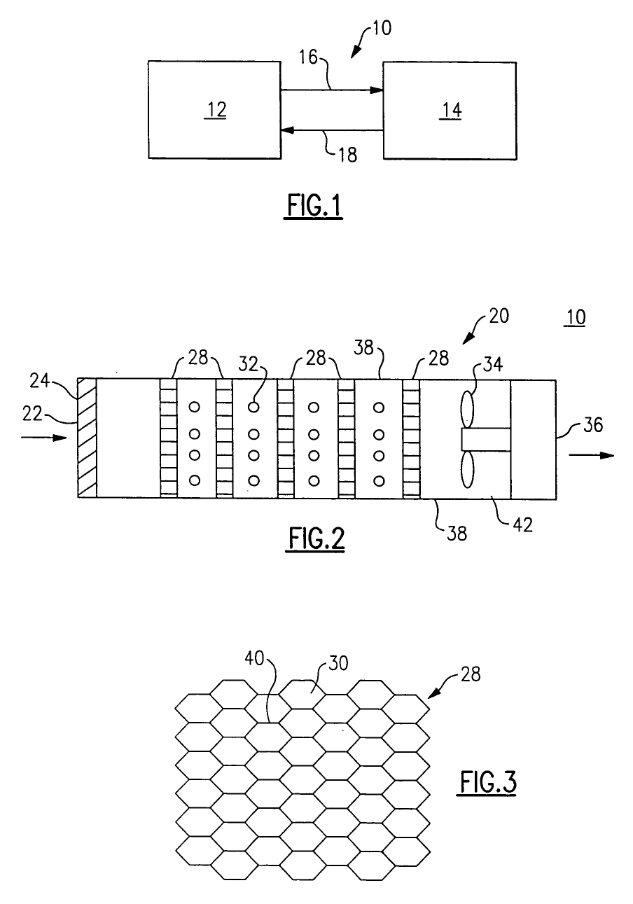

FIG. 1 schematically illustrates a building, vehicle, or other structure 10 including an interior space 12, such as a room, an office or a vehicle cabin, such as a car, train, bus or aircraft. An HVAC system 14 heats or cools the interior space 12. Air in the interior space 12 is drawn by a path 16 into the HVAC system 14. The HVAC system 14 changes the temperature of the air drawn 16 from the interior space 12. If the HVAC system 14 is operating in a cooling mode, the air is cooled. Alternately, if the HVAC system 14 is operating in a heating mode, the air is heated. The air is then returned back by a path 18 to the interior space 12, changing the temperature of the air in the interior space 12.

FIG. 2 schematically illustrates an air purification system 20 employed to purify the air in the building or vehicle 10 by oxidizing contaminants, such as volatile organic compounds and semi-volatile organic compounds, carbon monoxide to water, carbon dioxide, and other substances. For example, the volatile organic compounds can be aldehydes, ketones, alcohols, aromatics, alkenes, or alkanes. The air purification system 20 also decomposes ozone to oxygen. The air purification system 20 can purify air before it is drawn along path 16 into the HVAC system 14 or it can purify air leaving the HVAC system 14 before it is blown along path 18 into the interior space 12 of the building or vehicle 10. The air purification system 20 can also be a stand alone unit that is not employed with a HVAC system 14.

A fan 34 draws air into the air purification system 20 through an inlet 22. The air flows through a particle filter 24 that filters out dust or any other large particles by blocking the flow of these particles. The air then flows through a substrate 28, such as a honeycomb. In one example, the honeycomb 28 is made of aluminum or an aluminum alloy. FIG. 3 schematically illustrates a front view of the honeycomb 28 having a plurality of hexagonal open passages or channels 30. The surfaces of the plurality of open passages 30 are coated with a layered photocatalytic/thermocatalytic coating 40.

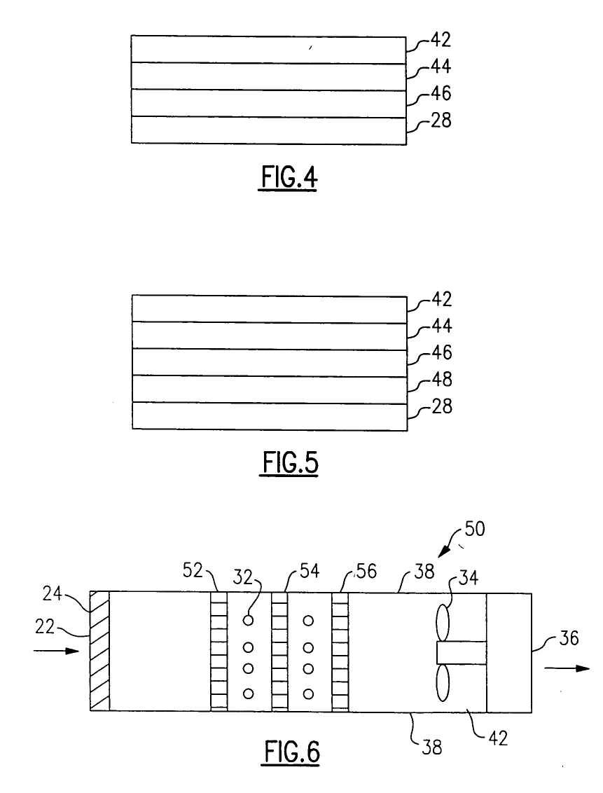

As shown in FIG. 4, the coating 40 of the present invention includes at least three layers. Preferably, the coating 40 has a loading of approximately 0.5-1 mg/cm² on the honeycomb 28. The coating 40 includes an outer layer 42 of titanium dioxide or a metal oxide doped titanium dioxide. The outer layer 42 is effective in oxidizing volatile organic compounds and semi-volatile organic compounds, such as aldehydes, ketones, alcohols, aromatics, alkenes or alkanes. Titanium dioxide is an effective photocatalyst to oxidize volatile organic compounds to carbon dioxide, water and other substances. The outer layer 42 has an effective thickness (less than 2 μm) and porosity. That is, the outer layer 42 is able to allow other contaminants that are not oxidized by the outer layer 42, such as low polarity organic compounds, carbon monoxide, and ozone, to diffuse through the outer layer 42 and adsorb on the layers under the outer layer 42.

A light source 32 positioned between successive honeycombs 28 activates the photocatalytic coating 40 on the surface of the open passages 30. As shown, the honeycombs 28 and the light source 32 alternate in the air purification system 20. That is, there is a light source 32 located between each of the honeycombs 28. Preferably, the light source 32 is an ultraviolet light source which generates light having a wavelength in the range of 180 nanometers to 400 nanometers.

The light source 32 is illuminated to activate the outer layer 42 on the surface of the honeycomb 28. When the photons of the ultraviolet light are absorbed by the outer layer 42, an electron is promoted from the valence band to the conduction band, producing a hole in the valence band. The electrons that are promoted to the conduction band are captured by the oxygen. The holes in the valence band react with water molecules adsorbed on the outer layer 42 to form reactive hydroxyl radicals.

When a volatile organic compound is adsorbed onto the outer layer 42, the hydroxyl radical attacks the volatile organic compound, abstracting a hydrogen atom from the volatile organic compound. In this method, the hydroxyl radical oxidizes the volatile organic compounds and produces water, carbon dioxide, and other substances.

Preferably, the photocatalyst is titanium dioxide. In one example, the titanium dioxide is Millennium titania, Degussa P-25, or an equivalent titanium dioxide. However, it is to be understood that other photocatalytic materials or a combination of titanium dioxide with other metal oxides can be employed. For example, the photocatalytic materials can be Fe₂O₃, ZnO, V₂O₅, SnO₂, or FeTiO₃. Additionally, other metal oxides can be mixed with titanium dioxide, such as Fe₂O₃, ZnO, V₂O₅, SnO₂, CuO, MnOₓ, WO₃, Co₃O₄, CeO₂, ZrO₂, SiO₂, Al₂O₃, Cr₂O₃, or NiO,

Additionally, if the outer layer 42 is a metal oxide loaded titanium dioxide, the titanium dioxide of the intermediate layer 44 can be loaded with a metal compound, such as WO₃, ZnO, CdS, SrTiO₃, Fe₂O₃, V₂O₅, SnO₂, FeTiO₃, PbO, Co₃O₄, NiO, CeO₂, CuO, SiO₂, Al₂O₃, MnₓO₂, Cr₂O₃, or ZrO₂.

An intermediate layer 44 of a catalytically active metal supported on a titanium dioxide or a titanium dioxide monolayer treated photocatalyst with very high dispersed catalytically active metal or metal is applied under the outer layer 42. Preferably, the titanium dioxide is loaded with a Group VIII noble metal, such rhodium, ruthenium, palladium, iridium, osmium, or platinum. However, the titanium dioxide can also be loaded with copper, silver, rhenium, gold, or the like. More preferably, the metal or metals are chosen with some regard to the catalysts expected substrate. Therefore, if more than on metal is used, the metal can be dispersed as a very small nano-crystal containing individual metals or a very small mixed metal clusters. Typically, a catalytic metal for this function is platinum. The catalytically active metal can also be a metal alloy or an intermetallic compound.

The catalytically active metal supported on titanium dioxide intermediate layer 44 is highly reactive with low polarity organic compounds. Platinum deposited on the surface of titanium dioxide enhances the separation of charge carriers, decreasing the recombination rate of the electrons and holes. Platinum is also a good thermal catalyst. It is believed that platinum can further oxidize the photocatalytic oxidation intermediates to carbon dioxide and water. Low polarity organic molecules have an increased affinity to platinum. When low polarity organic compounds adsorbs on the platinum, the platinum retains the low polarity organic compounds on the coating 40 for oxidation by the hydroxyl radicals, oxidizing the low polarity organic compounds to carbon dioxide in the presence of oxygen.

Platinum dispersed on titanium dioxide exhibits photocatalytic behavior for low contaminant concentrations, such as below 50 ppm. The photocatalytic oxidation rate of ozone, ethylene and butane is greater for platinum on titanium dioxide that for titanium dioxide alone. The photocatalytic oxidation rate is double for ozone and butane and between 2 to 14 times for ethylene over platinum on titanium dioxide. The photocatalytic oxidation rate of ethylene depends on humidity and ethylene concentrations. Surprisingly, the photocatalytic oxidation of these contaminants increases with increasing water vapor. In contrast, the photocatalytic oxidation of contaminants with titanium dioxide alone decreases with increased humidity.

The highly dispersed platinum particles on the surface of the titanium dioxide reduce the recombination rate of the electrons and the holes, increasing the photocatalytic activity of the coating. Preferably, the platinum particles have a size less than 5 nanometers and form platinum islands of about 1.0-1.5 nanometers. The preferred platinum loading is between 0.1% and 5.0%.

The intermediate layer 44 has an effective thickness and porosity. That is, the intermediate layer 44 is able to allow other contaminants that are not oxidized by the intermediate layer 44, such as carbon monoxide and ozone, to pass through the intermediate layer 44 and adsorb on the layers under the intermediate layer 44.

A thermocatalytic inner layer 46 is applied and deposited on the surface of the honeycomb 28 under the intermediate layer 44. The inner layer 46 is either nano-dispersed gold on titanium dioxide, gold on mixed metal oxides including titanium dioxide, gold on titanium dioxide which is loaded with other metal oxides on the surface, or gold containing mixed metal clusters.

At room temperature, the inner layer 46 oxidizes carbon monoxide to carbon dioxide. When carbon monoxide adsorbs on the coating, the gold acts as an oxidation catalyst and lowers the energy barrier of the carbon monoxide, oxidizing the carbon monoxide to carbon dioxide in the presence of oxygen. Therefore, the inner layer 46 acts as a thermocatalyst.

Carbon monoxide oxidation occurs mainly on the perimeter interface of the gold particles. Carbon monoxide is adsorbed on either surface or perimeter sites of the gold to form carbonyl species. Oxygen is adsorbed on the gold/titanium dioxide surface. It is believed that the oxygen is adsorbed onto the perimeter interface. The carbonyl species on the perimeter sites react with the oxygen, forming an oxygen-gold-carbon monoxide complex. The complex is decomposed to produced carbon dioxide.

Preferably, the gold particles have a size less than 3 nanometers. For the thermocatalytic function, the size of the gold particles is also critical to the activity of the carbon monoxide oxidation, which is dependent on the gold being formed into nano-particles.

The titanium dioxide can also be loaded with a metal oxide to further improve the thermocatalytic effectiveness of the inner layer 46. Gold particles have a tendency to migrate on the surface of the titanium dioxide to form large clusters. The effectiveness of the inner layer 46 can be decreased due to the migration of the gold particles. By loading a metal oxide on the surface of the titanium dioxide, the metal oxide can separate the gold particles and prevent them from migrating and forming clusters, therefore increasing the effectiveness of the inner layer 46. Preferably, a metal oxide is employed to immobilize the gold particles on the surface of the titanium dioxide. In one example, the metal oxide is at least one of WO₃, ZnO, CdS, SrTiO₃, Fe₂O₃, V₂O₅, SnO₂, FeTiO₃, PbO, Co₃O₄, NiO, CeO₂, CuO, SiO₂, Al₂O₃, MnₓO₂, Cr₂O₃, or ZrO₂.

This can also include titanium dioxide or titanium dioxide treated with a monolayer of another metal oxide having titanium dioxide decorated with isolated sites containing one or more, but typically less than, 12 oxidized atoms of another metal, such as iron, cobalt, and rhenium and the like, that function as anchor sites for the sub 3 nm gold particles. The surface dopant sites surrounded by titanium dioxide or its treatment metal monolayer function as surface energy potential wells that restrain free motion of gold.

The inner layer 46 has an effective thickness and porosity. That is, the inner layer 46 is able to allow other contaminants that are not oxidized by the inner layer 46, such as ozone, to pass through the inner layer 46 and adsorb on any layer that is under the inner layer 46.

As shown in FIG. 5, in environments where ozone concentrations are very high, a thermocatalytic fourth layer 48 can be applied under the inner layer 46, directly on the honeycomb 28. The fourth layer 48 is a manganese oxide/titanium dioxide ozone destruction catalyst. At room temperature, the fourth layer 48 decomposes ozone to oxygen.

At ambient temperatures, the manganese oxide is effective in decomposing ozone. Manganese oxide facilitates the decomposition of ozone to adsorbed surface oxygen atoms. These oxygen atoms then combine with ozone to form an adsorbed peroxide species that desorbs as molecular oxygen. When ozone adsorbs on the manganese oxide, the manganese oxide acts as a site for dissociative ozone adsorption by lowering the energy barrier required for ozone decomposition. Therefore, in the presence of ozone alone, the manganese oxide including manganese oxide and promoter doped manganese oxide produces oxygen.

If a fourth layer 48 is employed, the fourth layer 48 is applied on the honeycomb 28, the inner layer 46 is applied on the fourth layer 48, the intermediate layer 44 is applied on the inner layer 46, and the outer layer 42 is applied on the intermediate layer 44.

After passing through the honeycombs 28, the purified air then exits the air purifier through an outlet 36. The walls 38 of the air purification system 20 are preferably lined with a reflective material 42. The reflective material 42 reflects the ultraviolet light onto the surface of the open passages 30 of the honeycomb 28.

Additionally, a detailed description of coating processes are disclosed in co-pending patent application Ser. No. 10/449,752 filed May 30, 2003 entitled Tungsten Oxide/Titanium Dioxide Photocatalyst for Improving Indoor Air Quality, patent application Ser. No. 10/464,942 filed on Jun. 19, 2003 entitled Bifunctional Manganese Oxide/Titanium Dioxide Photocatalyst/Thermocatalyst for Improving Indoor Air Quality, and pending patent application Ser. No. 10/465,025 filed on Jun. 19, 2003 and entitled Bifunctional Gold/Titanium Dioxide Photocatalyst/Thermocatalyst for Improving Indoor Air Quality, the disclosures of which are incorporated by reference in its entirety. Related information on bifunctional manganese oxide/titanium dioxide photocatalyst/thermocatalyst is also disclosed in pending patent application Ser. No. 10/464,942. Related information on bifunctional gold/titanium dioxide photocatalyst/thermocatalyst is also disclosed in pending patent application Ser. No. 10/465,024.

FIG. 6 illustrates an alternate example of the air purification system 50. In this example, the air first flows through a first honeycomb 52, through a second honeycomb 54, and then through a third honeycomb 56 having a manganese oxide/titanium dioxide coating. One of the first honeycomb 52 and the second honeycomb 54 has a titanium dioxide coating or a metal oxide doped titanium dioxide coating. The metal oxide can be WO₃, ZnO, SrTiO₃, Fe₂O₃, V₂O₅, SnO₂, FeTiO₃, PbO, Co₃O4, NiO, CeO₂, CuO, SiO₂, Al₂O₃, Mn,O₂, Cr₂O₃, or ZrO₂. The metal oxide doped titanium dioxide coating oxidizes contaminants, such as volatile organic compounds and semi-volatile organic compounds, to water and carbon dioxide. The other of the first honeycomb 52 and the second honeycomb 54 has a gold/titanium dioxide coating that oxidizes carbon monoxide to water and carbon dioxide. The manganese oxide/titanium dioxide coating decomposes ozone to oxygen and water.

By employing a honeycomb with a metal oxide doped titanium dioxide coating, a honeycomb with a gold/titanium dioxide coating, and a third honeycomb 54 with a manganese oxide/titanium dioxide coating, carbon monoxide, ozone, volatile organic compounds, and semi-volatile organic compounds can be oxidized and destroyed. Therefore, the air purification system 50 including the metal oxide doped titanium dioxide coated honeycomb, the gold/titanium dioxide coated honeycomb, and the manganese oxide/titanium dioxide coated honeycomb 60 can perform the same function as the layered coating having a layer 48 of manganese oxide/titanium dioxide, a layer 46 of gold/titanium dioxide, and a layer 42 of metal oxide/titanium dioxide.

It is to be understood that the honeycombs 52, 54 and 56 can be in any order. However, ozone is a strong oxidation agent and is able to assist the photocatalytic oxidation process. Therefore, it is preferred that the air flows through the metal oxide doped titanium dioxide honeycomb 56 last. Alternately, the air purification system 50 includes more than one first honeycomb 52, second honeycomb 54 and third honeycomb 56.

Although a honeycomb 28 has been illustrated and described, it is to be understood that the photocatalytic/thermocatalytic coating 40 can be applied on any structure. The voids in a honeycomb 28 are typically hexagonal in shape, but it is to be understood that other void shapes can be employed. As contaminants adsorb onto the photocatalytic/thermocatalytic coating 40 of the structure in the presence of a light source, the contaminants are oxidized into water, carbon dioxide and other substances.

The foregoing description is only exemplary of the principles of the invention. Many modifications and variations of the present invention are possible in light of the above teachings. The preferred embodiments of this invention have been disclosed, however, so that one of ordinary skill in the art would recognize that certain modifications would come within the scope of this invention. It is, therefore, to be understood that within the scope of the appended claims, the invention may be practiced otherwise than as specifically described. For that reason the following claims should be studied to determine the true scope and content of this invention.

1. A purification system comprising:
a substrate; and
a layered catalytic coating applied on said substrate, and said layered catalytic coating comprises a first layer of a photocatalytic coating, a second layer of a photocatalytic metal loaded metal compound coating, and a third layer of a thermocatalytic coating.

2. The purification system as recited in claim 1 wherein said first layer is one of titanium dioxide and a metal compound loaded titanium dioxide.

3. The purification system as recited in claim 2 wherein said first layer is a metal compound loaded titanium dioxide coating and said metal compound is at least one of WO₃, ZnO, CdS, SrTiO₃, Fe₂O₃, V₂O₅, SnO₂, FeTiO₃, PbO, Co₃O₄, NiO, CeO₂, CuO, SiO₂, Al₂O₃, MnₓO₂, Cr₂O₃, and ZrO₂.

4. The purification system as recited in claim 1 wherein said first layer has a thickness less than 2 μm.

5. The purification system as recited in claim 1 wherein said second layer is a catalytically active metal supported on titanium dioxide.

6. The purification system as recited in claim 5 wherein said catalytically active metal is one of a metal alloy and an intermetallic compound supported on said titanium dioxide.

7. The purification system as recited in claim 5 wherein said catalytically active metal is a Group VIII noble metal.

8. The purification system as recited in claim 7 wherein said Group VIII noble metal is one of rhodium, ruthenium, palladium, iridium, osmium, and platinum.

9. The purification system as recited in claim 5 wherein said catalytically active metal is one of silver and rhenium.

10. The purification system as recited in claim 1 wherein said second layer oxidizes low polarity organic molecules.

11. The purification system as recited in claim 1 wherein said third layer comprises gold on a metal oxide, and said metal oxide is one of titanium dioxide, mixed metal oxides including titanium dioxide, and titanium dioxide loaded with a second metal oxide.

12. The purification system as recited in claim 11 wherein said third layer oxidizes carbon monoxide.

13. The purification system as recited in claim 1 wherein said third layer is applied on said substrate, said second layer is applied on said third layer, and said first layer is applied on said second layer.

14. The purification system as recited in claim 1 further comprising a manganese oxide/metal oxide layer applied on said substrate, and said third layer is applied on said manganese oxide/metal oxide layer, said second layer is applied on said third layer, and said first layer is applied on said second layer.

15. The purification system as recited in claim 14 wherein said manganese oxide/metal oxide layer is manganese oxide and a promoter doped manganese oxide/titanium dioxide.

16. The purification system as recited in claim 14 wherein manganese oxide/metal oxide layer decomposes ozone.

17. The purification system as recited in claim 1 further comprising a light source to activate said layered catalytic coating, and said layered catalytic coating oxidizes contaminants that are adsorbed onto said layered catalytic coating when activated by said light source.

18. The purification system as recited in claim 17 wherein said light source is an ultraviolet light source.

19. The purification system as recited in claim 17 wherein photons from said light source are absorbed by said layered catalytic coating, forming a reactive hydroxyl radical that oxidizes said contaminants in the presence of oxygen and water, and said reactive hydroxyl radical oxidizes said contaminants to water and carbon dioxide.

20. The purification system as recited in claim 17 wherein said contaminants are at least one of a volatile organic compound and a semi-volatile organic compound including at least one of aldehyde, ketone, alcohol, aromatic, alkene, and alkane.

21. The purification system as recited in claim 1 wherein said first layer, said second layer and said third layer are porous.

22. A fluid purification system comprising:
a container having an inlet and an outlet;
a porous substrate inside said container;
a device for drawing a fluid into said container through said inlet, flowing said fluid through said porous substrate, and expelling said fluid out of said container through said outlet;
a layered catalytic coating applied on said substrate, and said layered catalytic coating includes a first layer of a photocatalytic metal oxide coating, a second layer of a photocatalytic noble metal loaded metal oxide coating, and a third layer of a thermocatalytic coating, and said third layer is gold/metal oxide; and
an ultraviolet light source to activate said catalytic coating, and photons from said ultraviolet light source are absorbed by said layered catalytic coating to form a reactive hydroxyl radical, and said reactive hydroxyl radical oxidizes contaminants in said fluid that are adsorbed onto said layered catalytic coating when activated by said light ultraviolet light source to water and carbon dioxide in the presence of water and oxygen.

23. The fluid purification system as recited in claim 22 wherein said fluid is air.

24. A purification system comprising:
a first substrate having a first coating of one of titanium dioxide and metal compound/titanium dioxide; and
a second substrate having a second coating of metal/titanium dioxide; and
a third substrate having a third coating of metal oxide/titanium dioxide.

25. The purification system as recited in claim 24 wherein said first coating is metal compound/titanium dioxide, said second coating is gold/titanium dioxide, and said third coating is manganese oxide/titanium dioxide.

26. The purification system as recited in claim 25 wherein a metal compound of said metal oxide/titanium dioxide is at least one of WO₃, ZnO, SrTiO₃, Fe₂O₃, V₂O₅, SnO₂, FeTiO₃, PbO, Co₃O₄, NiO, CeO₂, CuO, SiO₂, Al₂O₃, MnₓO₂, Cr₂O₃, and ZrO₂

27. The purification system as recited in claim 25 wherein said third substrate is distal to an inlet of said purification system, and said first substrate and said second substrate are proximate to said inlet of said purification system.

28. A method of purification comprising the steps of:
applying a layered catalytic coating applied on said substrate, and said layered catalytic coating comprises a first layer of a photocatalytic coating, a second layer of a photocatalytic metal loaded metal compound coating, and a third layer of a thermocatalytic coating; and
activating said a layered catalytic coating;
forming a reactive hydroxyl radical;
adsorbing contaminants onto said layered catalytic coating;
oxidizing said contaminants with said hydroxyl radical;
lowering an energy barrier of oxidation of carbon monoxide with said gold of said third layer of said gold/metal oxide coating; and
then oxidizing said carbon monoxide.
